(19) United States
(12) Patent Application Publication
(10) Pub. No.: US 2026/0022274 A1
(43) Pub. Date: Jan. 22, 2026

(54) Multi-Layered Device with Water Activable Self-Adhering Film

(71) Applicant: Can Image Media Tech LLP, Mumbai (IN)

(72) Inventors: Ketan Desai, Mumbai (IN); Karunesh Mishra, Thane (IN)

(21) Appl. No.: 18/681,304

(22) PCT Filed: Oct. 10, 2023
(86) PCT No.: PCT/IN2023/050919

§ 371 Date: Feb. 5, 2024

(30) Foreign Application Priority Data
May 31, 2023 (IN) 202321037651

(51) Int. Cl. C09J 7/32; B32B 7/06; B32B 7/12; B32B 27/06; B32B 27/10; B32B 27/32; B32B 27/36; C09J 5/02; C09J 11/04

(52) U.S. Cl. CPC C09J 7/32; B32B 7/06; B32B 7/12; B32B 27/06; B32B 27/10; B32B 27/32; B32B 27/36; C09J 5/02; C09J 11/04; B32B 2255/12; B32B 2255/26; B32B 2307/728; B32B 2307/73; B32B 2405/00; C09J 2301/208; C09J 2301/414

(57) ABSTRACT

The present invention relates to a multi-layered device of the present invention includes at least three layers, a first “Base Layer” (A), a second “Release Layer” (B) on the “Base layer” (A), a third “Water-activable Base Coat Layer” (C) which is activable with water without the use of any co-solvent, optionally coated with additional layers on the “Water-activable Base Coat Layer” (C). The combined layers (A) and (B) form the Release Liner [(A)(B)] and the combined layer (C) and the optionally coated additional layers to form a Film [(C)(Additional layers)] of 15 GSM to 300 GSM. The Film is separable form “Release Liner [(A)(B)]. The Layer (C) includes hydrophilic & hydrophobic polymers wherein the ratio of hydrophilic to hydrophobic polymers is in the range of 1:0 to 1:10. The Film is water activable, printable and may be pigmented, transferable, and self-adhering on any surface.

### CROSS REFERENCE TO RELATED APPLICATIONS

This application is the United States national phase of International Patent Application No. PCT/IN2023/050919 filed Oct. 10, 2023, and claims priority to Indian Patent Application No. 202321037651 filed May 31, 2023, the disclosures of which are hereby incorporated by reference in their entireties.

### BACKGROUND OF THE INVENTION

### Field of the Invention

The present invention relates to a multi-layered device comprising water activable self-adhering films capable of being transferred onto diverse substrates without the use of solvents and extensive pre-working of surfaces as is essential in conventional painting s.

### Description of Related Art

Conventional painting applications require extensive treatment and working of the surfaces to be painted including long drying time for further processing. Further, several liquid paints contain Volatile Organic Compounds (VOCs) in the range of 35 ml to 100 ml per litre, which is hazardous to health and the environment. In several cases, the lingering odour of freshly painted surfaces causes allergic reactions and unpleasantness.

U.S. Pat. No. 6,277,229 B1 discloses a method of first printing an image onto an image transfer sheet that comprises in succession a water-permeable de-tack layer, a water-accepting layer, a water-activatable adhesive layer, a water-impermeable layer, and a flexible backing, and then transferring the image to a substrate without the addition of heat. The water-permeable de-tack layer includes three water-soluble ingredients, including polyacrylic acid (PAA), polyvinyl alcohol (PVOH) and starch. A problem with a film made entirely of PVOH is that the film may tend to transfer as a whole during the image transfer. To overcome this deficiency in U.S. Pat. No. 6,277,229 B1, a water-soluble starch is added to the PVOH layer to increase the brittleness of the layer. An image is printed onto the image transfer sheet with liquid ink, thereby activating the adhesive in the areas onto which the ink has been printed, wherein the adhesive gets activated to a tacky state without the addition of heat. The sheet is applied to the substrate to adhere the image to the substrate. After applying the sheet to the substrate, the sheet is pulled off the substrate to leave the portions of adhesive that bear the image attached to the substrate but leaving the portions of the adhesive that do not bear the image attached to the sheet.

It is to be noted that in US 6,277,229 B1 to print and transfer an image onto a substrate necessarily requires multiple layers comprising a water-permeable de-tack layer, a water-accepting layer, a water-activatable adhesive layer, a water-impermeable layer, and a flexible backing. Clearly, multiple sets of layers are needed to print and transfer an image onto a substrate.

Several earlier attempts to provide a Multi-Layered Device comprising water activable self-adhering films capable of being transferred onto diverse substrates, without the use of solvents and extensive pre-working of surfaces have not been possible. Adhesive layer disclosed in prior art necessarily requires one or more solvents in combination with water for activation. Activation of the Adhesive Layer using only water without any co-solvent has continued to be an unmet need.

There is an unmet need to provide a multi-layered device comprising printable water-activable self-adhering film that is transferable onto any surface, obviating the use of solvents, extensive pre-working of surfaces, substantially reducing painting time and avoiding discomfort related to lingering paint odour. As mentioned earlier, activation of the self-adhering film using only water without any co-solvent has continued to be an unmet need.

### OBJECT OF THE INVENTION

The main object of the invention is to provide a multi-layered device comprising water activable self-adhering films that are activated only with water without the use of any co-solvent, environment-friendly, PVC free, VOC free, and transferable onto any surface obviating the use of solvents, extensive pre-working of surfaces, substantially reducing painting time and avoiding issues related to lingering paint odour.

Yet another object of the invention is to provide the said multi-layered device comprising pigmented films.

Another object of the invention is to provide the said multi-layered device comprising films, transferable onto metallic, non-metallic, irrespective of the surface shape and texture of the substrate.

Yet another object of the invention is to provide the said films being capable of being printed using diverse printing inks and printing methods.

Another object is to provide said films that conform with EN-71 Part 3.

Yet another object of the invention is to provide the said films that are transferable onto surfaces with speed thereby reducing the surface painting time substantially as compared to the time taken in conventional painting processes.

Yet another object of the invention is to provide the said films that are washable and demonstrate water resistance.

Yet another object of the invention is to provide the said films that are tamper-resistant.

Yet another object of the invention is to provide the said films that are abrasion resistant.

Yet another object of the invention is to provide the said multi-layered device that is capable of cost-effective commercial scale production and use for surface protection and decoration.

Yet another object of the invention is to provide the said multi-layered device that is easily amenable for public use as a Do-it-Yourself (DIY) product.

### SUMMARY OF THE INVENTION

The multi-layered device of the present invention comprises at least three layers, a first “Base Layer” (A), a second “Release Layer” (B) on the “Base layer” (A), a third “Water-activable Base Coat Layer” (C), optionally coated with additional layers on the “Water-activable Base Coat Layer” (C), wherein the combined layers (A) and (B) form the Release Liner [(A)(B)] and the combined layer (C) and the optionally coated additional layers to form a Film [(C)(Additional layers)].

The first “Base Layer (A)” is a liner material typically selected from paper or plastic. The second “Release Layer (B)” is preferably selected from a group of release agents. The third “Water-activable Base Coat Layer” (C) comprises a mixture of hydrophilic and hydrophobic polymers in the ratio of 1:0 to 1:10 on solids basis.

In another embodiment of the present invention, the third “Water-activable Base Coat Layer” (C) has an additional “Printable Layer” (Cy),
wherein the “Water-activable Base Coat Layer” (C) comprises a mixture of hydrophilic and hydrophobic polymers in the ratio of 1:0 to 1:10 on solids basis, and
wherein the “Printable Layer” (Cy) comprises a mixture of hydrophilic and hydrophobic polymers in the ratio of 1:2 to 1:50 on solids basis.

In yet another embodiment of the present invention, the “Water-activable Base Coat Layer” (C) comprises a mixture of hydrophilic and hydrophobic polymers in the ratio of 1:0 to 1:10 on solids basis, and
an additional “Top Coat Layer” (D) comprising a mixture of hydrophilic and hydrophobic polymers in the ratio of 1:0 to 1:70 on solids basis, synthetic rubber 1-13% w/w of Layer (D), and hydroxyl reactive polysilanols 0.5-5% w/w of Layer (D), and optionally pigment(s) 15-45% w/w of Layer (D),
The “Water-activable Base Coat Layer” (C) is activable with water without the use of any co-solvent(s).

### BRIEF DESCRIPTION OF THE DRAWINGS

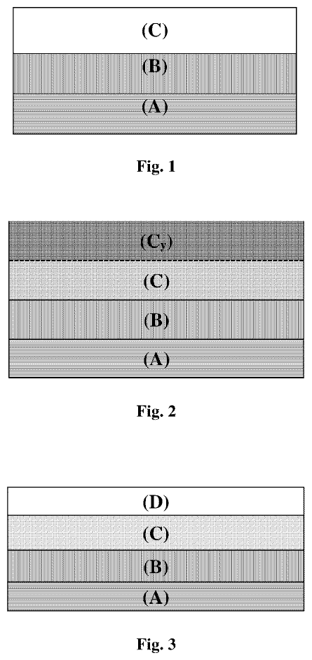

FIG. 1 shows a device of the present invention comprising at least three layers:
a “Base Layer (A)
a “Release Layer” (B) coated on the Layer (A)
Combination of layer (A) and Layer (B) forms the “Release liner” [(A)(B)].
a “Water-activable Base Coat Layer” (C) is coated on the Layer B.
Layer C forms “Film” [(C)].

FIG. 2 shows a device of the present invention comprising at least three layers:
a “Base Layer (A)
a “Release Layer” (B) coated on the Layer (A)
Combination of layer (A) and Layer (B) forms the “Release liner” [(A)(B)].
a “Water-activable Base Coat Layer” (C) coated on Layer (B)
a “Printable Layer” (Cy) coated on Layer (C)
Combination Layer (C) and Layer (Cy) forms “Film” [(C)(Cy)].

FIG. 3 shows a device of the present invention comprising at least three layers:
a “Base Layer (A)
a “Release Layer” (B) coated on the Layer (A)
Combination of layer (A) and Layer (B) forms the “Release liner” [(A)(B)].
a “Water-activable Base Coat Layer” (C) coated on Layer (B)
a “Top Coat Layer” (D) coated on the Layer (C)
Combination of Layers (C) and (D) forms “Film” [(C)(D)]

### DESCRIPTION OF THE INVENTION

The invention is described with reference to the accompanying drawing. However, it is made clear that the description only illustrates the invention and in no way limits the same.

The terms and words used in the following description are not limited to their literal meanings. The description is representative of the illustrative embodiments and examples. The drawings and/or illustrations in no way limit the scope of the invention. It is understood that modifications and/or alterations of the drawings/illustrations of this invention other than those specifically set forth herein may be achieved by those skilled in the art and that such modifications and alterations are to be considered as falling within the overall scope of this invention.

Referring to the drawings, FIG. 1 shows a device of the present invention comprising at least three layers:
a “Base Layer (A)
a “Release Layer” (B) coated on the Layer (A)
Combination of layer (A) and Layer (B) forms the “Release liner” [(A)(B)].
a “Water-activable Base Coat Layer” (C) is coated on the Layer B.
Layer C forms “Film” [(C)] of 15 GSM to 70 GSM

In another embodiment of the present invention as shown in FIG. 2 comprises:
a “Base Layer (A)
a “Release Layer” (B) coated on the Layer (A)
Combination of layer (A) and Layer (B) forms the “Release liner” [(A)(B)].
a “Water-activable Base Coat Layer” (C) coated on Layer (B)
a “Printable Layer” (Cy) coated on Layer (C)
Combination Layer (C) and Layer (Cy) forms “Film” [(C)(Cy)] of 15 GSM to 70 GSM.

In another embodiment of the present invention as shown in FIG. 3 comprises:
a “Base Layer (A)
a “Release Layer” (B) coated on the Layer (A)
Combination of layer (A) and Layer (B) forms the “Release liner” [(A)(B)].
a “Water-activable Base Coat Layer” (C) coated on Layer (B)
a “Top Coat Layer” (D) coated on the Layer (C)
Combination of Layers (C) and (D) forms “Film” [(C)(D)] of 15 GSM to 300 GSM.

“Base Layer” (A) is a liner material, typically selected from paper or plastics.

The paper in “Base Layer” (A) is selected from Super Calendered Kraft (SCK) paper, poly-coated Kraft paper, Glassine, Clay Coated Kraft (CCK) paper, Machine Finished Kraft (MFK) paper, or Machine Glazed (MG) paper.

In an embodiment wherein the “Base Layer” (A) is plastic, the plastic is selected from PET film (biaxially oriented), poly-coated BO-PET film, BOPP (biaxially oriented PP film) or other polyolefins typically comprising HDPE, LDPE or PP plastic resins.

“Release Layer” (B) is selected from a group of silicone release agents, phosphate ester, alkylated phosphorylated esters, fluoro-polymer, preferably silicone release agents

The “Water-activable Base Coat Layer” (C) as shown in FIG. 1 is coated on “Release Layer” (B), which acts as water activable as well as printable film capable of being transferred and adhered to any surface, comprises of hydrophilic & hydrophobic polymers wherein the ratio of hydrophilic to hydrophobic polymers is in the range of 1:0 to 1:10, preferably 1:5 to 1:8, and most preferably 1:5 to 1:7 on solids basis. Further, the Layer (C) may be pigmented to obtain coloured film.

In another embodiment of the present invention as shown in FIG. 2, the “Water-activable Base Coat Layer” (C) comprises hydrophilic & hydrophobic polymers wherein the ratio of hydrophilic:hydrophobic polymers is in the range of 1:0 to 1:10, preferably 1:1 to 1:3, and most preferably 1:1 to 1:1.5 on solids basis. The film [(C)(Cy)] further comprises of a “Printable Layer” (Cy) which serves as the ink receptive coat, comprising of hydrophilic & hydrophobic polymers wherein the ratio of hydrophilic:hydrophobic polymers is in the range of 1:2 to 1:50, preferably 1:4 to 1:30, and most preferably 1:6 to 1:10 on solids basis. Further, the Layers (C) and/or (Cy) may be pigmented to obtain coloured film.

In yet another embodiment of the present invention as shown in FIG. 3, Layer (C) comprises a mixture of hydrophilic & hydrophobic polymers. The ratio of hydrophilic to hydrophobic polymers is in the range 1:0 to 1:10, preferably 1:1 to 1:3, and most preferably 1:1 to 1:1.5 on solids basis.

Layer (D) comprises a mixture of hydrophilic & hydrophobic polymers, synthetic rubber, preferably SBR, hydroxyl reactive polysilanols, and optionally pigment(s). The ratio of hydrophilic to hydrophobic polymers is in the range of 1:0 to 1:70, preferably 1:30 to 1:60, and most preferably 1:40 to 1:50 on solids basis.

In Layer (D), synthetic rubber is 1-13% w/w, preferably 1-8% w/w of Layer (D), hydroxyl reactive polysilanols 0.5-5% w/w, preferably 1-3% w/w of Layer (D), and optionally pigment(s) 15-45% w/w, preferably 20-25% w/w of Layer (D).

The hydrophilic polymer in Layer (C), Layer (Cy), and Layer (D) is selected from polyvinyl alcohol, polyvinyl pyrrolidone, starch, dextrin, hydroxy ethyl cellulose, hydroxy propyl cellulose, methyl hydroxyethyl cellulose, preferably polyvinyl alcohol, and polyvinyl pyrrolidone.

hydrophobic polymer in Layer (C), Layer (Cy), and Layer (D) is selected from acrylic polymers emulsion/synthetic rubber preferably SBR/polyvinyl acetate latex/styrene acrylic co-polymer emulsion, preferably styrene-acrylic co-polymer emulsion, and group of acrylic polymers, polyamides, epoxy resins, polyesters, and poly-olefins, and group of synthetic rubbers.

Solvents to dissolve hydrophobic polymers are selected from group of Ketones, Esters, Alcohols, Aromatic hydrocarbons, Ester-alcohols, and Alcohol-Ketones.

In all the embodiments, pigment(s) may be added in the process to obtain a colored film. Further, dry film preservatives may be added in the film, to obtain a bacterial-resistant film. Additional layers may be coated or applied in the form of varnish or waterproof coating layer, or laminating on the Film.

### Process for the Preparation of the Multilayer Device of the Present Invention

The process to prepare the embodiment of the present invention as shown in FIG. 1, comprises steps:
1. Preparation of the “Release Liner” [(A)(B)]
   “Base Layer” (A) is coated with a release agent to obtain the “Release Layer” (B) and dried at 160° C. to 180° C.
2. Coating of the “Release Liner” [(A)(B)] with the “Water-activable Base Coat Layer” (C)
   a. Hydrophobic polymer emulsion/solution is taken in a mixing tank and stirred at high speed.
   b. A dispersing agent is added to the hydrophobic polymer emulsion/solution under stirring followed by optional addition of titanium dioxide (Rutile) paste under stirring to achieve homogenization.
   c. Solution of hydrophilic polymer is added to the above mixture under stirring. optionally mixing defoamer, flow & levelling agent, and dry-film preservatives, and removing extraneous matter if any to obtain a “coating dope”,
   d. The coating dope obtained in step (c), is coated on “Release Layer” (B) and dried at 120° C. to 130° C., to obtain a Layer “C” comprising hydrophilic & hydrophobic polymers wherein the ratio of hydrophilic:hydrophobic polymers is in the range of 1:0 to 1:10, preferably 1:5 to 1:8, and most preferably 1:5 to 1:7 on solids basis., the layer having GSM of 15 to 70,
   e. Additional layers may be coated or applied on the Film, in the form of varnish or waterproof coating layer, or laminating with an additional film.

The process to prepare the embodiment of the present invention as shown in FIG. 2, comprises steps:
1. Preparation of the “Release Liner” [(A)(B)]
   “Base Layer” (A) is coated with a release agent to obtain the “Release Layer” (B) and dried at 160° C. to 180° C.
2. Coating of the “Release Liner” [(A)(B)] with “Water-activable Base Coat Layer” (C) and “Printable Layer” (Cy)
   a. Hydrophobic polymer emulsion is taken in a mixing tank and stirred at high speed.
   b. A dispersing agent is added to the hydrophobic polymer emulsion under stirring followed by optional addition of titanium dioxide (Rutile) paste under stirring to achieve homogenization.
   c. A solution of hydrophilic polymer is added to the above mixture under stirring. Optionally mixing defoamer, flow & levelling agent, and dry-film preservatives, and removing extraneous matter if any to obtain a “coating dope”,
   d. The coating dope obtained in step (c), is coated on “Release Layer” (B) and dried at 120° C. to 130° C., to obtain a “Water-activable Base Coat Layer” (C) comprising hydrophilic & hydrophobic polymers wherein the ratio of hydrophilic:hydrophobic polymers is in the range of 1:0 to 1:10, preferably 1:1 to 1:3, and most preferably 1:1 to 1:1.5 on solids basis, the layer having GSM of 10 to 30,
   e. The “Water-activable Base Coat Layer” (C) is further coated by an ink-receptive coat “Printable Layer” (Cy), comprising hydrophilic & hydrophobic polymers wherein the ratio of hydrophilic:hydrophobic polymers is in the range of 1:2 to 1:50, preferably 1:4 to 1:30,and most preferably 1:6 to 1:10 on solids basis to obtain a layer of 5 to 60 GSM and dried at 120° C. to 130° C. Coating dope for “Printable Layer” (Cy) is manufactured in the similar way as coating dope for “Water-activable Base Coat Layer” (C),
   f. Additional layers may be coated or applied on the Film [(C)(Cy)], in the form of varnish or waterproof coating layer, or laminating with an additional film.

The process to prepare the embodiment of the present invention as shown in FIG. 3, comprises steps:
1. Preparation of the “Release Liner” [(A)(B)]
   “Base Layer” (A) is coated with a release agent to obtain the “Release Layer” (B) and dried at 160° C. to 180° C.
2. Coating of the “Release Liner” [(A)(B)] with the “Water-activable Base Coat Layer” (C)
   A “Coating Dope” is prepared and then coated on the “Release Liner” [(A)(B)] in steps:
   a. A hydrophobic Polymer emulsion/solution is taken in a mixing tank and stirred at high speed,
   b. A dispersing agent is added to the hydrophobic Polymer emulsion/solution under stirring followed by optional addition of titanium dioxide (Rutile) paste under stirring to achieve homogenization,
   c. A solution of hydrophilic polymer is added to the above mixture under stirring, optionally mixing defoamer, flow & levelling agent, and dry-film preservatives, and removing extraneous matter if any to obtain a “coating dope”,
   d. Coating the “Release Liner” [(A)(B)] with the “coating dope” to achieve 10 to 30 GSM and drying at 120° C. to 130° C., to remove water to obtain a “water activable” surface as “Water-activable Base Coat Layer” (C), wherein the ratio of hydrophilic:hydrophobic polymers is in the range of 1:0 to 1:10, preferably 1:1 to 1:3, and most preferably 1:1 to 1:1.5 on solids basis,
3. Coating of the “Release Liner” [(A)(B)] coated with “Water-activable Base Coat Layer” (C) with “Top Coat Layer” (D)
   “Top Coat Layer” (D) is prepared and then coated on the “Water-activable Base Coat Layer” (C) in steps:
   a. A hydrophobic Polymer emulsion/solution is stirred at high speed preferably at 800 to 1000 rpm,
   b. A dispersing agent is added to the hydrophobic Polymer emulsion/solution under stirring followed by optional addition of titanium dioxide (Rutile) paste and coloured fine pastes, under stirring to achieve homogenization,
   c. A solution of hydrophilic polymer is added to the above mixture under with stirring, followed by sequential addition of synthetic rubber preferably SBR Latex/solution and hydroxyl reactive polysilanols under stirring, optionally mixing defoamer, flow & levelling agent, and dry-film preservatives, and removing extraneous matter if any to obtain a “coating dope”,
   d. Coating the “Water-activable Base Coat Layer” (C) with the “coating dope” of step (c) to achieve 5 to 270 GSM and drying at 120° C. to 130° C., to achieve the Film [(C)(D)] of 15 to 300 GSM, wherein the ratio of hydrophilic to hydrophobic polymers is in the range of 1:0 to 1:70, preferably 1:30 to 1:60, and most preferably 1:40 to 1:50 on solids basis. In “Top Coat Layer” (D), synthetic rubber preferably SBR is 2-8% w/w, preferably 2-5% w/w of total batch charge, optional addition of pigment(s) 15-45% w/w, preferably 20-25% w/w based on solid content of batch charge, and hydroxyl reactive polysilanols 0.1-3% w/w, preferably 0.5-1.5% w/w of batch charge,
   e. Additional layers may be coated or applied on the “Top Coat Layer” (D) in the form of varnish or waterproof coating layer, or laminating with an additional film.

The invention is illustrated with non-limiting examples below:

### Example 1

Multi-Layered Device with Tamper-Resistant, Water Activable, Printable Film C Preparation of the Multi-Layered Device Having Tamper-Resistant Printable Film [(C)]:
i. “Base Layer” (A) 90 GSM CCK (Clay Coated Kraft) paper was coated with silicone and dried at 170 to 180 C.° to obtain a “Release Layer” (B) of 1.0 to 1.5 GSM. This silicone-coated CCK paper was used as “Release Liner” [(A)(B)].
ii. A “coating dope” was prepared as follows:
   Acrylic co-polymer emulsion (54% solids content) was taken in a mixing pot, and 0.3% of dispersing agent was added under high-speed mixing, followed by the addition of 30% of Titanium dioxide (ATR 312, Rutile) paste (75% solids) based on total batch charge.
   Mixing was continued and Polyvinyl alcohol solution (13.5% solids content, in water) was added under mixing, keeping PVA:Acrylic co-polymer ratio 1:5.3, followed by the addition of 0.3% of deformer and 0.3% of flow & levelling agent, and mixed for 10 minutes. It was filtered to obtain “coating dope”.
iii. The “coating dope” was used to coat “Release Liner” [(A)(B)] on the layer (B), dried at 120-130° C. to achieve a coating of 30-32 GSM of “Water-activable Base Coat Layer” (C).

### Example 2:

Multi-Layered Device with Tamper-Resistant, Water Activable, Printable Film [(C)(Cy)]:
i. “Base Layer” (A) 90 GSM CCK (Clay Coated Kraft) paper was coated with silicone and dried at 170 to 180 C.° to obtain a “Release Layer” (B) of 1.0 to 1.5 GSM. This silicone-coated CCK paper was used as Release Liner [(A)(B)].
ii. Coating Dope for Layer “Water-activable Base Coat Layer” (C) was prepared as follows:
   Acrylic co-polymer emulsion (54% solids content) was taken in a mixing pot, and 0.4% of dispersing agent was added under high-speed mixing, followed by the addition of 14% of Titanium dioxide (ATR 312, Rutile) paste (75% solids) based on total batch charge.
   Mixing was continued and Polyvinyl alcohol solution (13.5% solids content, in water) was added under stirring, keeping PVA:Acrylic co-polymer ratio 1:1.33, and then filtered to obtain a “coating dope for “Water-activable Base Coat Layer” (C)”.
iii. The “coating dope for “Water-activable Base Coat Layer” (C)” was used for coating on “Release Liner” [(A)(B)], dried at 120-130° C. to achieve a coating weight of 12-13 GSM of “Water-activable Base Coat Layer” (C)”.
iv. A “coating dope for “Printable Layer” (Cy)” was prepared as follows:
   Acrylic co-polymer emulsion (54% solids content) was taken in a mixing pot, and 0.25% of dispersing agent was added under high-speed mixing, followed by the addition of 30% of Titanium dioxide (ATR 312, Rutile) paste (75% solids) based on total batch charge.
   Mixing was continued and Polyvinyl alcohol solution (13.5% solids content, in water) was added under mixing, keeping PVA:Acrylic co-polymer ratio 1:10, followed by the addition of 0.3% of deformer and 0.3% of flow & levelling agent, and mixed for 10 minutes. It was filtered to obtain “coating dope for “Printable Layer” (Cy)”.
v. The “coating dope for “Printable Layer” (Cy)” was used to coat “Water-activable Base Coat Layer” (C), dried at 120-130° C. to achieve a coating of 15-16 GSM of “Printable Layer” (Cy) resulting in a total film [(C)(Cy)] with GSM of 27-29.

### Example 3

Multi-Layered Device with Tamper-Resistant, Water Activable, Printable Film [(C)(Cy)]:
i. “Base Layer” (A) 90 GSM CCK (Clay Coated Kraft) paper was coated with silicone and dried at 170 to 180 C.° to obtain a “Release Layer” (B) of 1.0 to 1.5 GSM. This silicone-coated CCK paper was used as “Release Liner” [(A)(B)].
ii. Coating Dope for Layer “Water-activable Base Coat Layer” (C) was prepared as follows:
   Acrylic co-polymer emulsion (54% solids content) was taken in a mixing pot, and 0.4% of dispersing agent was added under high-speed mixing, followed by the addition of 11% of Titanium dioxide (ATR 312, Rutile) paste (75% solids) based on total batch charge.
   Mixing was continued and Polyvinyl alcohol solution (13.5% solids content, in water) was added under stirring, keeping PVA:Acrylic co-polymer ratio 1:0.55, and then filtered to obtain a “coating dope for “Water-activable Base Coat Layer” (C)”.
iii. The “coating dope for “Water-activable Base Coat Layer” (C)” was used for coating on “Release Liner” [(A)(B)], dried at 120-130° C. to achieve a coating weight of 15-16 GSM of “Water-activable Base Coat Layer” (C).
iv. A “coating dope for “Printable Layer” (Cy)” was prepared as follows:
   Acrylic co-polymer emulsion (54% solids content) was taken in a mixing pot, and 0.25% of dispersing agent was added under high-speed mixing, followed by the addition of 25% of Titanium dioxide (ATR 312, Rutile) paste (75% solids) based on total batch charge.
   Mixing was continued and Polyvinyl alcohol solution (13.5% solids content, in water) was added under mixing, keeping PVA:Acrylic co-polymer ratio 1:8, followed by the addition of 0.3% of deformer and 0.4% of flow & levelling agent, and mixed for 10 minutes. It was filtered to obtain “coating dope for “Printable Layer” (Cy).
v. The “coating dope for “Printable Layer” (Cy)” was used to coat layer “Water-activable Base Coat Layer” (C), dried at 120-130° C. to achieve a coating of 22-24 GSM of “Printable Layer” (Cy) resulting in a total film [(C)(Cy)] with GSM of 37-40.

### Example 4

Multi-Layered Device with Water Resistance Water Activable Film [(C)(D)]
i. “Base Layer” (A) 90 GSM CCK (Clay Coated Kraft) paper was coated with silicone and dried at 170 to 180 C.° to obtain a “Release Layer” (B) of 1.0 to 1.5 GSM. This silicone-coated CCK paper was used as “Release Liner” [(A)(B)].
ii. Coating Dope-1 was prepared as follows:
   Acrylic co-polymer emulsion (54% solids content) was taken in a mixing pot, and 0.4% of dispersing agent was added under high-speed mixing, followed by the addition of 13% of Titanium dioxide (ATR 312, Rutile) paste (75% solids) based on total batch charge.
   Mixing was continued Polyvinyl alcohol solution (13.5% solids content, in water) was added under stirring keeping PVA:Acrylic co-polymer ratio 1:1, followed by the addition of 0.3% of deformer and 0.4% of flow & levelling agent, and mixed for 10 minutes. It was filtered to obtain a “coating dope 1”.
iii. The “coating dope 1” was used for coating on “Release Liner” [(A)(B)], dried at 120-130° C. to achieve a coating weight of 18-20 GSM of “Water-activable Base Coat Layer” (C).
iv. A “coating dope 2” was prepared as follows:
   Acrylic co-polymer emulsion (54% solids content) was taken in a mixing pot, and 0.4% of dispersing agent was added under high-speed mixing followed by the addition of 20% of Titanium dioxide (ATR 312, Rutile) paste (75% solids) based on the solid content of batch charge, 2.5% of SBR Latex and 2.5% of hydroxyl reactive polysilanols) based on total batch charge.
   Mixing was continued and Polyvinyl alcohol solution (13.5% solids content, in water) was added under mixing, keeping PVA:Acrylic co-polymer ratio 1:40, followed by addition of 0.9% of dry film preservative and mixed for 10 minutes. It was filtered to obtain “coating dope 2”.
v. The “coating dope 2” was used to coat “Water-activable Base Coat Layer” (C), dried at 120-130° C. to achieve a coating of 80-90 GSM of “Top Coat Layer” (D) resulting in a total film [(C)(D)] GSM of 100-110.

### Example-5

Multi-Layered Device with Tamper-Resistant, Water Activable, Printable Film [(C)(Cy)]:
i. “Base Layer” (A) 90 GSM CCK (Clay Coated Kraft) paper was coated with silicone and dried at 170 to 180 C.° to obtain a “Release Layer” (B) of 1.0 to 1.5 GSM. This silicone-coated CCK paper was used as Release Liner [(A)(B)].
ii. Coating Dope for Layer “Water-activable Base Coat Layer” (C) was prepared as follows:
   Acrylic co-polymer emulsion (54% solids content) was taken in a mixing pot, and 0.4% of dispersing agent was added under high-speed mixing, followed by the addition of 14% of Titanium dioxide (ATR 312, Rutile) paste (75% solids) based on total batch charge.
   Mixing was continued and Polyvinyl alcohol solution (13.5% solids content, in water) was added under stirring, keeping PVA:Acrylic co-polymer ratio 1:1.33, and then filtered to obtain a “coating dope for “Water-activable Base Coat Layer” (C)”.
iii. The “coating dope for “Water-activable Base Coat Layer” (C)” was used for coating on “Release Liner” [(A)(B)], dried at 120-130° C. to achieve a coating weight of 12-13 GSM of “Water-activable Base Coat Layer” (C)”.
iv. A “coating dope for “Printable Layer” (Cy)” was prepared as follows:
   Acrylic polymer solution (50% solids content) was taken in a mixing pot, and 0.30% of dispersing agent was added under high-speed mixing, followed by the addition of 30% of Titanium dioxide (ATR 312, Rutile) paste (75% solids) based on total batch charge.
   Mixing was continued and PVPK-30 (Polyvinyl Pyrrolidone K-30) solution (30% solids content) was added under mixing, keeping PVPK-30:Acrylic polymer ratio 1:10, followed by the addition of 0.3% of flow & levelling agent, and mixed for 10 minutes. It was filtered to obtain “coating dope for “Printable Layer” (Cy)”.
v. The “coating dope for “Printable Layer” (Cy)” was used to coat “Water-activable Base Coat Layer” (C), dried at 120-130° C. to achieve a coating of 15-16 GSM of “Printable Layer” (Cy) resulting in a total film [(C)(Cy)] with GSM of 27-30.

### Example-6

Multi-Layered Device with Water Resistance Water Activable Film [(C)(D)]
i. “Base Layer” (A) 90 GSM CCK (Clay Coated Kraft) paper was coated with silicone and dried at 170 to 180 C° to obtain a “Release Layer” (B) of 1.0 to 1.5 GSM. This silicone-coated CCK paper was used as “Release Liner” [(A)(B)].
ii. Coating Dope-1 was prepared as follows:
   Acrylic co-polymer emulsion (54% solids content) was taken in a mixing pot, and 0.4% of dispersing agent was added under high-speed mixing, followed by the addition of 13% of Titanium dioxide (ATR 312, Rutile) paste (75% solids) based on total batch charge.
   Mixing was continued Polyvinyl alcohol solution (13.5% solids content, in water) was added under stirring keeping PVA:Acrylic co-polymer ratio 1:1, followed by the addition of 0.3% of deformer and 0.4% of flow & levelling agent, and mixed for 10 minutes. It was filtered to obtain a “coating dope 1”.
iii. The “coating dope 1” was used for coating on “Release Liner” [(A)(B)], dried at 120-130° C. to achieve a coating weight of 18-20 GSM of “Water-activable Base Coat Layer” (C).
iv. A “coating dope 2” was prepared as follows:
   Acrylic polymer solution (50% solids content) was taken in a mixing pot, and 0.4% of dispersing agent was added under high-speed mixing followed by the addition of 20% of Titanium dioxide (ATR 312, Rutile) paste (75% solids) based on the solid content of batch charge, 3.0% of SBR and 2.0% of hydroxyl reactive polysilanols) based on total batch charge.
   Mixing was continued and PVPK-30 (Polyvinyl Pyrrolidone K-30) solution (30% solids content) was added under mixing, keeping PVPK:Acrylic polymer ratio 1:45, followed by addition of 0.8% of dry film preservative and mixed for 10 minutes. It was filtered to obtain “coating dope 2”.
v. The “coating dope 2” was used to coat “Water-activable Base Coat Layer” (C), dried at 120-130° C. to achieve a coating of 90-100 GSM of “Top Coat Layer” (D) resulting in a total film [(C)(D)] GSM of 110-120.

### Application of the Film

The present invention addresses the hitherto unmet need by providing an multi-layered device comprising printable water-activated self-adhering film, which is environment friendly, PVC free, VOC free, and transferable onto any surface, obviating the need for use of solvents, extensive pre-working of surfaces, substantially reducing painting time and avoiding discomfort related to lingering paint odour.

### Application of the Multi-Layered Water Activable Device of the Present Invention

a) cleaning and wetting with water the substrate surface on which the film [(C)(D)] or [(C)(Cy)] or (C) is to be transferred,
b) peeling the film [(C)(D)] or [(C)(Cy)] or (C) from the “Release Liner” [(A)(B)],
c) laying the (C) side of the film onto the said pre-wetted substrate surface, wherein (C) gets activated to enable the transfer and adherence of the film onto the said substrate surface,
d) applying water on the top of (D)/(Cy)/(C) surface of the film and pressing the said top surface of the film to ensure adherence of the film onto the surface,
e) removing bubbles if any between the transferred film and the surface by known methods.

### Advantages

In addition to overcoming the drawbacks in the existing products, technologies, and practices related to the paint industry, the present invention provides multi-layered device comprising printable water-activable self-adhering films with significant benefits as they are:
Water activable self-adhering films that is activated with water without the use of any co-solvent.
Environment-friendly, PVC free, VOC free, transferable onto any surface, obviating the use of solvents, extensive pre-working of surfaces, substantially reducing painting time, avoiding discomfort related to lingering paint odour while conforming with EN-71 Part 3.
transferable onto metallic, non-metallic, for example, wall, ply, metal, tile, glass, wood, stone, cement, or plastic, irrespective of the surface shape and texture of the substrate.
capable of being loaded with pigment(s) and/or printed using diverse printing inks and printing methods.
of variable washable and water resistance.
Being tamper resistant.
capable of cost-effective commercial scale production and use for surface protection and decoration.
easily amenable for public use as a Do-it-Yourself (DIY) product.
capable for use in painting interior walls in residential & commercial establishments, printed graphic applications, advertising, promotions, labels, and other marketing campaigns, and surface coverings.

1. A Multi-Layered Device with Water Activable Self-Adhering Film comprising
at least three layers, a first “Base Layer” (A), a second “Release Layer” (B) on the “Base layer” (A), a third “Water-activable Base Coat Layer” (C), optionally coated with additional layers on the “Water-activable Base Coat Layer” (C),
wherein,
the combined layers (A) and (B) form the Release Liner [(A)(B)] and
the combined layer (C) and the optionally coated additional layers to form a Film [(C)(Additional layers)];
wherein the layer (C) and the optionally coated additional layer comprises hydrophilic and hydrophobic polymers,
wherein
the hydrophilic polymer is selected from polyvinyl alcohol, polyvinylpyrrolidone, starch, dextrin, hydroxy ethyl cellulose, hydroxy propyl cellulose, methyl hydroxyethyl cellulose, preferably polyvinyl alcohol, and polyvinyl pyrrolidone,
and
the hydrophobic polymer is selected from acrylic polymers emulsion/latex preferably SBR latex/polyvinyl acetate latex/styrene acrylic polymer emulsion, preferably styrene-acrylic polymer emulsion, and group of acrylic polymers, polyamides, epoxy resins, polyesters, and poly-olefins, and group of synthetic rubbers.

2. The multi-layered device as claimed in claim 1, wherein the “Water-activable Base Coat Layer” (C) comprises mixture of hydrophilic and hydrophobic polymers in the ratio of 1:0 to 1:10 preferably 1:5 to 1:8, and most preferably 1:5 to 1:7 on solids basis, and optionally pigment(s), the Layer (C) forming Film (C) of 15-70 GSM.

3. The multi-layered device as claimed in claim 1, wherein the “Water activable Base Coat Layer” (C) comprises hydrophilic & hydrophobic polymers wherein the ratio of hydrophilic:hydrophobic polymers is in the range of 1:0 to 1:10, preferably 1:1 to 1:3, and most preferably 1:1 to 1:1.5 on solids basis, wherein the Layer (C) is coated with a “Printable Layer” (Cy) comprising a mixture of hydrophilic and hydrophobic polymers in the ratio of 1:2 to 1:50, preferably 1:4 to 1:30, and most preferably 1:6 to 1:10 on solids basis, and Layers (C) and or (Cy) optionally pigment(s), the combination of Layers (C) and (Cy) forming “Film” [(C)(Cy)] of 15-70 GSM.

4. The multi-layered device as claimed in claim 1, wherein the “Water activable Base Coat Layer” (C) comprises hydrophilic & hydrophobic polymers wherein the ratio of the hydrophilic to hydrophobic polymers is in the range 1:0 to 1:10, preferably 1:1 to 1:3, and most preferably 1:1 to 1:1.5 on solids basis, wherein the Layer (C) is coated with a Layer (D), comprising a mixture of hydrophilic & hydrophobic polymers, wherein the ratio of hydrophilic to hydrophobic polymers is in the range of 1:0 to 1:70, preferably 1:30 to 1:60, and most preferably 1:40 to 1:50 on solids basis, SBR Latex is 1-13% w/w, preferably 1-8% w/w of Layer (D), hydroxyl reactive polysilanols 0.5-5% w/w, preferably 1-3% w/w of Layer (D), and optionally pigment(s) 15-45% w/w, preferably 20-25% w/w of Layer (D), the combination of Layers (C) and (D) forming “Film” [(C)(D)] of 15-300 GSM.

5. A process for the preparation of the multi-layered device claimed in claim 1, comprising at least three layers, a first “Base Layer” (A), a second “Release Layer” (B) on the “Base layer” (A), a third “Water-activable Base Coat Layer” (C), comprises steps:
i. Coating the “Base Layer” (A) with a release agent to obtain the “Release Layer” (B) and drying at 160° C. to 180° C. to obtain the “Release Liner” [(A)(B)];
ii. Coating of the “Release Liner” [(A)(B)] with the “Water-activable Base Coat Layer” (C), in steps
a. adding a dispersing agent to a stirred hydrophobic polymer emulsion followed by optional addition of titanium dioxide (Rutile) paste under stirring,
b. adding under stirring solution of hydrophilic polymer to the mixture in step (a), optionally mixing defoamer, flow & levelling agent, and dry-film preservatives, and removing extraneous matter if any to obtain a “coating dope”,
c. coating the “Release Layer” (B) of the “Release Liner” [(A)(B)] with the “coating dope” obtained in step (b), and drying at 120° C. to 130° C., to obtain a Layer “C” comprising hydrophilic & hydrophobic polymers wherein the ratio of hydrophilic:hydrophobic polymers is in the range of 1:0 to 1:10, preferably 1:5 to 1:8, and most preferably 1:5 to 1:7 on solids basis., the layer having GSM of 15 to 70,
d. optionally coating or applying on the film a varnish or waterproof coating layer, or laminating with an additional film.

6. A process for the preparation of the multi-layered device claimed in claim 1, comprising at least three layers, a first “Base Layer” (A), a second “Release Layer” (B) on the “Base layer” (A), a third “Water-activable Base Coat Layer” (C), and an additional “Printable Layer” (Cy) on the Layer (C) in steps comprising:
i. Coating the “Base Layer” (A) with a release agent to obtain the “Release Layer” (B) and drying at 160° C. to 180° C. to obtain the “Release Liner” [(A)(B)];
ii. Coating of the “Release Liner” [(A)(B)] with the “Water-activable Base Coat Layer” (C), in steps
a. adding a dispersing agent to a stirred hydrophobic polymer emulsion followed by optional addition of titanium dioxide (Rutile) paste under stirring,
b. adding under stirring solution of hydrophilic polymer to the mixture in step (a), optionally mixing defoamer, flow & levelling agent, and dry-film preservatives, and removing extraneous matter if any to obtain a “coating dope”,
c. coating the “Release Layer” (B) of the “Release Liner” [(A)(B)] with the “coating dope” obtained in step (b), and drying at 120° C. to 130° C., to obtain a Layer “C” comprising hydrophilic & hydrophobic polymers wherein the ratio of hydrophilic:hydrophobic polymers is in the range of 1:0 to 1:10, preferably 1:1 to 1:3, and most preferably 1:1 to 1:1.5 on solids basis., to obtain a “Water-activable Base Coat Layer” (C) of GSM 10-30;
d. coating the “Water-activable Base Coat Layer” (C) with an ink receptive coat “Printable Layer” (Cy), comprising hydrophilic & hydrophobic polymers, wherein the ratio of hydrophilic:hydrophobic polymers is in the range of 1:2 to 1:50, preferably 1:4to 1:30, and most preferably 1:6 to 1:10 on solids, drying at 120° C. to 130° C. to obtain “Printable Layer” (Cy) of 5 to 60 GSM, the combination of Layers (C) and (Cy) forming “Film” [(C)(Cy)] of 15-70 GSM.
e. optionally coating or applying on the film a varnish or waterproof coating layer, or laminating with an additional film.

7. A process for the preparation of the multi-layered device claimed in claim 1, comprising at least three layers, a first “Base Layer” (A), a second “Release Layer” (B) on the “Base layer” (A), a third “Water-activable Base Coat Layer” (C), and an additional “Top Coat Layer” (D) on the Layer (C) in steps comprising:
i. Coating the “Base Layer” (A) with a release agent to obtain the “Release Layer” (B) and drying at 160° C. to 180° C. to obtain the “Release Liner” [(A)(B)];
ii. Coating of the “Release Liner” [(A)(B)] with the “Water-activable Base Coat Layer” (C), in steps
a. adding a dispersing agent to a stirred hydrophobic polymer emulsion followed by optional addition of titanium dioxide (Rutile) paste under stirring,
b. adding under stirring solution of hydrophilic polymer to the mixture in step (a), optionally mixing defoamer, flow & levelling agent, and dry-film preservatives, and removing extraneous matter if any to obtain a “coating dope”,
c. Coating the “Release Liner” [(A)(B)] with the “coating dope”, drying at 120° C. to 130° C., to remove water to obtain a “water activable” surface as “Water-activable Base Coat Layer” (C), wherein the ratio of Hydrophilic:Hydrophobic polymers is in the range of 1:0 to 1:10, preferably 1:1 to 1:3, and most preferably 1:1 to 1:1.5 on solids basis, to achieve 10 to 30 GSM,
iii. Coating the “Water-activable Base Coat Layer” (C) with “Top Coat Layer” (D) in steps:
f. mixing with stirring a dispersing agent with a hydrophobic polymer emulsion/solution followed by optional addition of titanium dioxide (Rutile) and pigment(s) under stirring,
g. adding with stirring, a solution of hydrophilic polymer to the mixture of step (a), followed by sequential addition of synthetic rubber and hydroxyl reactive polysilanols, optionally mixing defoamer, flow & levelling agent, and dry-film preservatives, and removing extraneous matter if any to obtain a “coating dope”,
c. coating the “Water-activable Base Coat Layer” (C) with the “coating dope” of step (b) and drying at 120° C. to 130° C., to obtain a “Top Coat Layer” (D), comprising, hydrophilic to hydrophobic polymers in the ratio of 1:0 to 1:70, preferably 1:30 to 1:60, and most preferably 1:40 to 1:50 on solids basis, synthetic rubber preferably SBR is 2-8% w/w, preferably 2-5% w/w of total batch charge, optional addition of pigment(s) 15-45% w/w, preferably 20-25% w/w based on solid content of batch charge, and hydroxyl reactive polysilanols 0.1-3% w/w, preferably 0.5-1.5% w/w of batch charge, to achieve a Film [(C)(D)] of 15 to 300 GSM preferably, of 60 to 170 GSM, and
d. coating additional layers on the “Top Coat Layer” (D) in the form of varnish or waterproof coating layer, or laminating with an additional film.

8. The “Base Layer (A)” claimed in claim 1, is a liner material selected from paper such as Super Calendered Kraft (SCK) paper, poly-coated Kraft paper, Glassine, Clay Coated Kraft (CCK) paper, Machine Finished Kraft (MFK) paper, or Machine Glazed (MG) paper.

9. The first “Base Layer (A)” as claimed in claim 1, is a liner material selected from plastics such as PET film (biaxially oriented), poly-coated BO-PET film, BOPP (biaxially oriented PP film) or other Polyolefins typically comprising HDPE, LDPE or PP plastic resins.

10. The “Release Layer (B)” as claimed in claim 1, is selected from a group of phosphate ester, alkylated phosphorylated esters, fluoro-polymer and silicone release agents.

11. The multi-layered device as claimed in claim 1, is environment friendly, PVC and VOC free and transferable onto any surface.

12. A process for the application of the films (C), or [(C)(Cy)], or [(C)(D)] of the multi-layered device as claimed in claim 1, on any surface metallic, non-metallic, irrespective of the
surface shape and texture comprise steps:
a) cleaning and wetting with water the substrate surface on which the film [(C)(D)] or [(C)(Cy)] or (C) is to be transferred,
b) peeling the film [(C)(D)] or [(C)(Cy)] or (C) from the “Release Liner” [(A)(B)],
c) laying the (C) side of the film onto the said pre-wetted substrate surface, wherein (C) gets activated to enable the transfer and adherence of the film onto the said substrate surface,
d) applying water on the top of (D)/(Cy)/(C) surface of the film and pressing the said top surface of the film to ensure adherence of the film onto the surface, and
e) removing bubbles if any between the transferred film and the surface by known methods.
